(19) United States
(12) Patent Application Publication
(10) Pub. No.: US 2019/0171268 A1
(43) Pub. Date: Jun. 6, 2019

(54) USB POWER DELIVERY

(71) Applicant: Displaylink (UK) Limited, Cambridge (GB)

(72) Inventors: Daniel Ellis, Cambridge (GB); Richard Jonathan Petrie, Guildford (GB)

(21) Appl. No.: 16/098,430

(22) PCT Filed: Apr. 18, 2017
(86) PCT No.: PCT/GB2017/051073

§ 371 Date: Nov. 1, 2018

(30) Foreign Application Priority Data
May 3, 2016 (GB) 1607708.3

(51) Int. Cl. G06F 1/26

(52) U.S. Cl. CPC G06F 1/266

(57) ABSTRACT

A USB dock (32) which includes a USB data hub (35) that does not provide negotiated power levels to devices connected to the USB dock (32), is connected to a host device (31) via a USB connection and to a peripheral device (33) via a USB connection and a power connection. The USB dock (32) includes a power source (37) connected to the power connection and a power controller (36) connected to the USB data hub (35), the power source (37) and the peripheral device (33). The power controller (36) receives instructions from the host device (31) to control the power source (37) to provide power to the peripheral device (33), communicates with the peripheral device (33) to determine parameters for power to be provided to the peripheral device (33), and controls the power source (37) to provide power at one of a plurality of different power levels to the peripheral device (33) via the power connection based on the instructions from the host device (31) and the determined parameters.

The present invention relates to a system for providing power delivery in a Universal Serial Bus (USB) system, and more particularly from a USB dock to a peripheral device connected to the USB dock.

### BACKGROUND

A conventional USB system is arranged as a tree with a host device at the trunk and all peripheral devices as branches. The dock is used to connect the host device to the peripheral devices and is transparent to the USB data signals that are addressed from one connected device to another. Such a USB dock may have only USB ports, or may also have one or more other types of port, such as a display connection, a network connection, or other connections. Power control signalling according to the USB defined Power Delivery protocol, however, is used purely to communicate directly between attached USB ports, commonly over dedicated wires in a USB cable.

Since it goes from port to port, such signalling cannot be passed through an entire tree from device to device without a specially-designed hub, which means that it is not possible for a USB host to send signals to control the power sent to and from peripherals without such a USB Power Delivery configured hub. Such USB Power Delivery configured hubs are able to send such power control signals in order to facilitate power negotiation between a peripheral and a power source in the dock, but are consequently more expensive and may not exist in legacy docking stations, which must therefore be altered in order for the Power Delivery protocol to be used. This is difficult and inconvenient for manufacturers of docking stations.

It is an object of the present invention to try to ameliorate this problem.

### SUMMARY

Accordingly, in a first aspect, the present invention provides a Universal Serial Bus, USB, dock comprising:

a USB data hub that does not provide negotiated power levels to devices connected to the USB dock;

at least a first port including a USB connection for connecting to a host device;

at least one second port for connecting to at least one peripheral device, the at least one second port including at least a USB connection connected to the USB data hub and a power connection;

a power source capable of providing power at a plurality of different power levels, the power source being connected to the power connection of the at least one second port; and

a power controller having a first connection to the power source, a second connection to the USB data hub and a third connection to the at least one second port, wherein the second connection is a USB data connection and the third connection is a power signalling connection;

wherein the power controller is configured to:

receive instructions from a host device connected to the first port via the USB data hub and the second connection, the instructions instructing the power controller to control the power source to provide power to a peripheral device connected to the at least one second port;

communicate with the peripheral device over the power signalling connection to determine parameters for power to be provided to the peripheral device; and

control the power source to provide power at one of the plurality of different power levels to the peripheral device via the power connection based on the instructions from the host device and the determined parameters.

In a preferred embodiment, the power signalling connection allows communication using a USB Power Delivery protocol. The power signalling connection may be connected to the power connection of the at least one second port or to a power signalling connection of the at least one second port. The at least one second port is preferably a USB Type C port.

In an embodiment, the USB dock comprises a plurality of second ports, and may further comprise one or more third ports for connection via non-USB connections to other peripheral devices.

According to a second aspect, the invention provides a method of power delivery from a USB dock to a peripheral device, the USB dock comprising:

a USB data hub that does not provide negotiated power levels to devices connected to the USB dock;

at least a first port including a USB connection for connecting to a host device;

at least one second port for connecting to at least one peripheral device, the at least one second port including at least a USB connection connected to the USB data hub and a power connection;

a power source capable of providing power at a plurality of different power levels, the power source being connected to the power connection of the at least one second port; and

a power controller having a first connection to the power source, a second connection to the USB data hub and a third connection to the at least one second port, wherein the second connection is a USB data connection and the third connection is a power signalling connection;

wherein the method comprises the power controller:

receiving instructions from a host device connected to the first port via the USB data hub and the second connection, the instructions instructing the power controller to control the power source to provide power to a peripheral device connected to the at least one second port;

communicating with the peripheral device over the power signalling connection to determine parameters for power to be provided to the peripheral device; and

controlling the power source to provide power at one of the plurality of different power levels to the peripheral device via the power connection based on the instructions from the host device and the determined parameters.

In a preferred embodiment, communicating with the peripheral device over the power signalling connection uses a USB Power Delivery protocol. Communicating with the peripheral device may use the power connection of the at least one second port or may use a power signalling connection of the at least one second port. The at least one second port preferably forms part of a USB Type C port.

Preferably, the instructions from the host device instruct the power controller to control the power source to provide power to the peripheral device based on a status of other peripheral devices connected to other second ports of the dock and on a capability of the power source. The instructions from the host device may instruct the power controller to control the power source to sink power from the peripheral device and/or may instruct the power controller to control the power source to sink power from one peripheral device connected to one second port and to provide power to another peripheral device connected to another second port.

Such a power controller which is connected to a hub that is not able to negotiate power levels to be provided to connected ports therefore acts as a proxy for such a hub. This allows system-wide power control to be provided to a host device.

This function may be carried out through a direct connection between the power controller and a port. Alternatively, the power controller may send signals to a dedicated module which then passes them on to a port, possibly by incorporating them into other signalling methods.

The power controller may also respond to requests for the status of each of the external ports of the docking station; such statuses may include connection status, negotiated power supply, whether the port is acting as a source or sink of power, or any other setting or attribute of the port, and could be used either for user feedback or for further control of the system. The power controller may then apply changes to the settings of the ports and thus change the status, in order to allow fine-tuning of port settings as appropriate for the requirements and limitations of connected devices.

For this purpose, the power controller is programmed with the specific port configurations of the hub and/or the docking station. This additional programming will allow a system policy manager, commonly a process run as part of the operating system of the host device, to communicate with the power controller while the power controller is aware of the port on which activity is occurring.

Preferably, the docking station is connected to the host and peripheral devices via USB and all signalling is according to the USB specifications.

Provision of the power controller means that the hub provided within the docking station may be simpler and therefore less expensive while still providing improved control of power supplied within the system and allowing for oversight of the whole of the system from the host. Because the power controller may be individually connected to ports, it also means that power delivery via the ports is more flexible and therefore a greater variety of devices can conveniently be connected and efficiently used. However, the docking station as a whole remains transparent to the connected devices and therefore the conventional networking structure—a tree, in the case of USB—is preserved. None of the devices need be aware of the fact that they are connected to a hub which is using a power controller as a proxy for power control and co-ordination rather than a hub which is capable of providing power delivery signalling and control itself. This means that no change to the operation of devices is required.

### BRIEF DESCRIPTION OF THE DRAWINGS

Embodiments of the invention will now be more fully described, by way of example, with reference to the drawings, of which:

FIG. 1 is a diagram of the system as a whole;

FIG. 2 is a basic diagram of the internal workings of a docking station arranged according to the current art;

FIG. 3 is a basic diagram of a docking station arranged to illustrate two embodiments of the invention; and

FIG. 4 is a flowchart outlining the method by which signals are transferred.

### DETAILED DESCRIPTION OF THE DRAWINGS

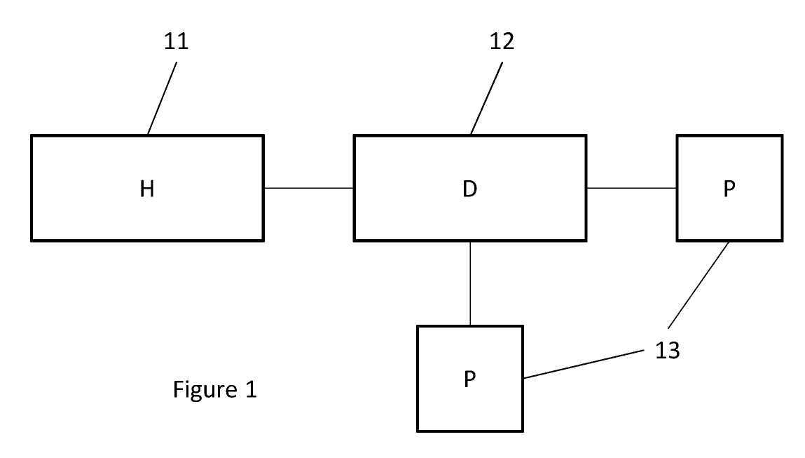

FIG. 1 shows a host device [11] connected to a USB docking station [12], which in turn is connected to two peripheral devices [13] in a general-purpose local network. The host device [11] may be a desktop computer or may be a mobile device such as a laptop, tablet computer, smartphone, wearable device, or any other such intelligent computing device. The peripheral devices [13] may be any devices that can be controlled by the host device [11], such as human interface devices, external hard disks, display devices, etc. and there may be any number of them. Hereinafter, the host device [11] and peripheral devices [13] may be collectively known as connected devices.

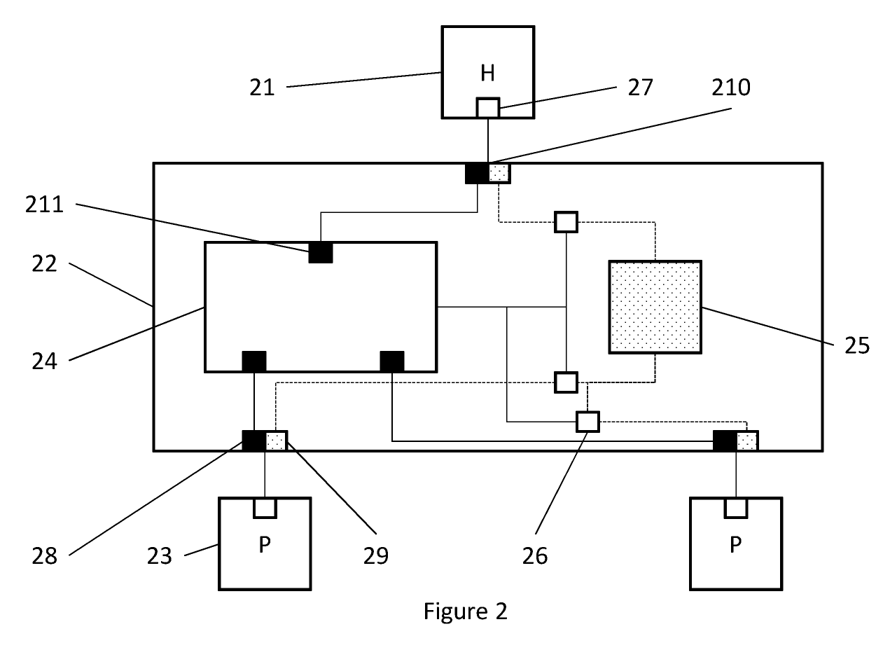

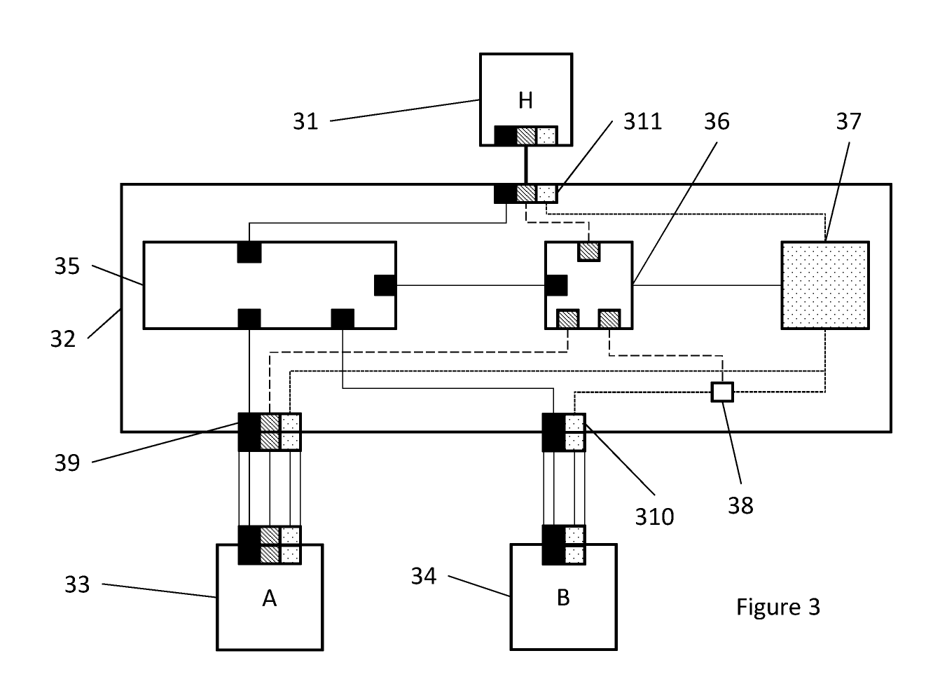

The connected devices [11, 13] are connected to external ports on the docking station [12], most likely by cables being physically connected to sockets in the external casing of the docking station [12]. Internally, these ports are then connected to internal ports in the hub contained in the docking station [12], as shown in FIGS. 2 and 3. The docking station [12] may have specific ports for the host device [11] and the peripheral devices [13], but the invention will be described as if all ports function identically unless otherwise specified.

Although two peripheral devices [13] connected via USB are shown here, there may in practice be additional peripheral devices connected to other ports via other protocols. These are not relevant to the invention and no such devices are shown here.

FIG. 2 shows a block diagram of a conventional docking station [22] arranged according to the known art, connected to a host device [21] and two peripheral devices [23], similarly to the system described in FIG. 1. Each of the connected devices [21, 23] has a device USB port, which may be a USB socket or the device end of a captive cable. This device port is then connected to an external port [210] on the docking station [22]. Each external port [210] consists of a data component (shown as a plain black square) [28] and a power component (shown as a square marked with dots) [29].

The data component [28] of the external port [210] is connected to an internal port [211] on the hub [24], which only supplies data to its connections. It is aware of which external ports [210] have devices [21, 23] connected to them and is able to use this information to turn the power supply to each individual external port [210] on and off by controlling a switch [26].

The power component [29] of each external port [210] is connected to a power source [25], which may be connected to mains electricity, or it may be a battery, or it may be a temporary power store such as a capacitor if the docking station [22] is not capable of providing power itself, as may be the case if it merely allows the host [21] to charge the peripheral devices [23], for example. Each power connection passes through one of the switches [26], which are controlled by the hub [24] so that no power passes down the respective connection if there is no device connected to the respective external port [210]. This is the only control that such a conventional hub [24] is able to exert over the power supplied by the docking station [22], and as a result each external port [210] can only provide the standard 5V supply required by the USB specification. This is undesirable, as devices often require more flexibility, and more recent technology, including the Power Delivery protocol, allows for larger power supplies that therefore require more careful control.

Power control can be incorporated into the hub [24], as mentioned above, but this is sometimes undesirable due to the expense and complexity of such a hub. Therefore, according to one embodiment of the present invention, a power control device is incorporated into the docking station, as is shown in FIG. 3.

FIG. 3 shows a similar USB docking station [32] to that shown in FIG. 2, connected to the same host [31] and peripheral [33, 34] devices. Similarly to the docking station of FIG. 2, the docking station [32] contains a hub [35] and a power source block [37]. The hub [35] is a conventional USB data hub which is not able to perform power control functions such as negotiation of power levels for the external ports [39, 310, 311] and the devices [31, 33, 34] connected to them. In this respect, it is the same as the hub [24] shown in FIG. 2.

The connected devices [31, 33, 34] are connected through USB as previously mentioned to external ports [39, 310, 311] of the docking station [32], with the host device [31] being connected to an upstream external port [311] and the peripheral devices [33, 34] being connected to downstream external ports [39, 310]. Unlike in the docking station [22] described in FIG. 2, however, the docking station [32] described in FIG. 3 is able to perform power control functions, such as supplying different power levels to different external ports [39, 310, 311] and negotiating the power supplies and requirements of connected devices [31, 33, 34]. This may be carried out through a power control component (shown as a square marked with diagonal hatching) of each external port [39, 311], or through alteration of an existing signal passing through an external port [310] which does not have such a component.

The two downstream external ports [39, 310] demonstrate different ways in which the power control device [36] can transmit and receive power control signals according to the invention. The operation of the first external port [39], which is connected to Peripheral A [33], will be discussed first.

This external port [39] incorporates the data, power control, and power components previously mentioned, and these are mated with corresponding connections within the cable connecting the connected device [33] to the docking station [32]. These internal connections are then in turn mated with components in the device port on the connected device [33]. The details of the different parts of the cable are shown in the connection between the peripheral device [33] and the docking station [32], but the cable between the host device [31] and the docking station [32] may be the same.

The data component of the external port [39] is, as in FIG. 2, connected to an internal port on the hub [35] and is only capable of carrying data. Such data will be formatted according to a USB protocol and addressed from device to device through the USB network.

The power component of the external port [39] is connected to the power block [37], as previously mentioned. In this docking station [32], however, there is no switch, as the power delivered and received by the power block [37] is controlled by the power control device [36] through a direct connection between the power control device [36] and the power block [37]. It is not necessary for the power block [37] to be connected to the upstream external port [311], but it is preferred and this embodiment is shown in FIG. 3.

Finally, the power control component is connected directly to the power control device [36]. This is responsible for sending control signals to the power block [37] to regulate the power sent to and taken from the various external ports [39, 310, 311]. Preferably, the power signals are formatted according to the USB Power Delivery protocol, as this will be most compatible with the USB protocols being used elsewhere in the system.

As well as receiving power control signals from the external ports [39, 310, 311], the power control device [36] is also able to receive signals from the connected devices [31, 33, 34] through its data connection to the hub [35], which is similar to those used by the connected devices [31, 33, 34] and formatted in the same way—i.e., as a USB data connection. This means that the connected devices [31, 33, 34] are able to send requests and other signals to the power control device [36] through the hub [35] as if the power control device [36] were another connected device.

The connection between the power control device [36] and the hub [35] is marked as non-removable, which means that the internal port associated with the power control device [36] cannot be re-configured and the hub [35] will always be aware of its presence. Furthermore, the power control device [36] can be programmed with the topology of all the ports relative to the port to which it is connected.

The host device [31] and the peripheral devices [33, 34] are likely to interact with the power control device [36] in different ways even assuming the upstream external port [311] is in fact connected to the power block [37], since the host device [31] is likely to be running the system policy manager which oversees power management throughout the system, and it is therefore not reliant on any part of the docking station [32] to be able to transmit power control signals. The upstream external port [311] is able to send signals directly to the power control device [36] through its direct power control signal line and thus negotiate its own power requirements and abilities. However, it cannot send such signals directly to the other external ports [39, 310] without, conventionally, the assistance of the hub, hence the fact that the power control device [36] is required to act as a proxy.

Operation of the power control device [36] is likely to be triggered by an attach signal from an external port [39, 310, 311]. This may take the form of a plug detection mechanism which sends a signal to the power control device [36]. Alternatively, the plug detection mechanism may send a signal to the hub [35] which in turn signals the power control device [36] through its dedicated data connection. Alternatively, upon connection the connected device [31, 33, 34] might send a power delivery signal such as a request for power to be supplied, and this will cause the external port [39, 310, 311] to send a power control signal to the power control device [36]. Finally, an internal manager on the power block [37] might be notified when a device [31, 33, 34] is connected and begins to draw power, and it might then send a signal to the power control device [36] through its dedicated connection. The power control device [36] can then query the external port [39, 310, 311], receive and act on requests regarding that port [39, 310, 311], and send signals to control the power block [37] as appropriate.

In order to transmit power control signals in the embodiment demonstrated by the first external port [39], the connection control device [36] hijacks the relevant parts of a connection—which would conventionally be connected through to the hub [35]—and changes the signals being sent directly by being connected directly to the power signalling component of the external port [39].

For example, if the connected device [33] is connected via a Type-C USB cable, this connection will include a CC wire and a VBus wire. The CC wire is commonly used for power control signalling, and the VBus wire commonly carries power. The power control connection could be connected directly to the CC line, and likewise for the power line and the VBus line.

A second embodiment, shown in the external port [310] connected to Peripheral B [34], operates differently. This external port [310] only has two components, and the connected cable also only has two lines which are connected to two components at the device port on Peripheral B [34]. As for the first external port [39], there is a data component which is connected directly to the internal port on the hub [35]. The other component is a power component, which is connected to the power block [37] via a modulation block [38]. The modulation block [38] is connected to the power control device [37] and is able to exchange power control signals with it. It is more complex than the switches [26] shown in FIG. 2 as it operates to incorporate the power control signals sent by the power control device [36] into the power supplied by the power block [37]. It will similarly decode any modulated power received and transmit the resulting power control signals to the power control device [36].

This embodiment will allow the use of ports and cables that do not have a dedicated power control line to transmit power control signals.

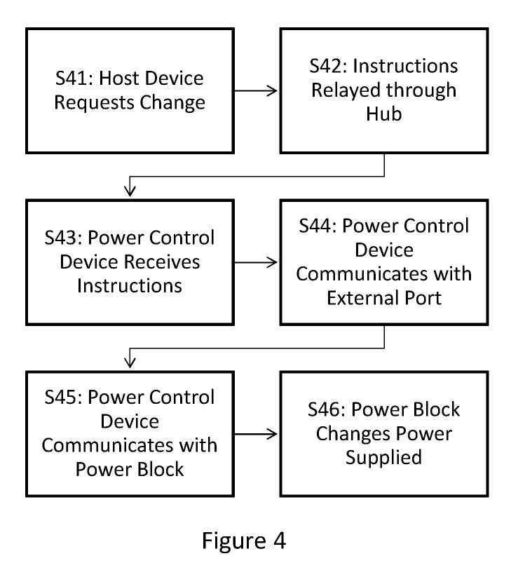

In both cases, the power control device [36] will operate in the same way, examples of which are outlined in FIG. 4.

At Step S41, the host device [31] requires a change in the power supply to or from a peripheral device [33, 34]. For example, it may be preparing to use an external hard drive, which will mean that the external hard drive will require more power. The host device [31] cannot use the direct power control connection from its own external port [311] to the power control device [36] as this is only useful for negotiating its own power supply. However, because the power control device [36] is connected to the hub [35] via a data connection, the host device [31] is able to transmit instructions as one or more USB data packets addressed to the power control device [36].

At Step S42, the data packets are received by the hub [35] through the internal connection between itself and the upstream external port [311]. The hub [35] treats the power control device [36] as another connected device in the same way as if it were a peripheral [33, 34], so it transmits the data packets down the data connection to the power control device [36].

At Step S43, the power control device [36] receives the data packets and decodes the instructions they contain, which will also include a reference to the downstream external port [39/310] to which the peripheral [33/34]—in this example, the external hard drive—is connected. It then prepares a power control signal, which it transmits at Step S44.

If the external hard drive is Peripheral A [33], the power control signal is transmitted directly from the power control device [36] to the power control component of the downstream external port [39]. It may amend the settings of the port, or may result in feedback. In this example, the power control signal will cause the external port [39] to transmit a similar power control signal on to the external hard drive [36] indicating that it is to begin drawing more power, and the external port [39] will accordingly draw more power from the power block [37].

If the external hard drive is Peripheral B [34], the power control signal will be transmitted from the power control device [36] to the modulation block [38]. This will apply frequency modulation to the power being drawn by the peripheral [34], meaning that the peripheral [34] will be able to interpret the modulated power in order to receive the same signal as if it had been transmitted directly down a dedicated line.

In either case, the power control device [36] will also communicate with the power block [37] at Step S45. It does this through its dedicated connection to the power block [37], and in this case will tell it to supply more power to the appropriate downstream external port [39/310].

In an example where the second peripheral [33/34] is a power supply, such as an external battery, the signal from the host [31] may also cause the power control device [36] to transmit power control signals to the second downstream external port [39/310], and hence to that peripheral [33/34], instructing it to supply more power. The power control device [36] will then also send a signal to the power block [37], instructing it to sink more power from that external port [39/310], allowing it to supply more power to the external hard drive [34/33] that the host [31] initially instructed should be supplied with more power. It may do this automatically, even if such signals are not explicitly requested in the instructions supplied by the host [31]. This means that instructions to the power block [37] to supply and sink power may be prompted either by instructions from the host device [31] or due to an automatic process.

Furthermore, if a peripheral device [33/34] sends a power control signal to the power control device [36] requesting more power without instruction from the host [31], the power control device [36] may either automatically instruct the power block [37] to supply more power or send a data message to the host [31] incorporating, for example, the statuses of the downstream external ports [39, 310] and connected devices [33, 34] and the available capability of the power block [37]. This message may prompt the host [31] to instruct the power control device [36] to instruct the power block [37] to supply more power to the peripheral [33/34]; as previously described, this may then also result in the power block [37] sinking more power from another peripheral [34/33].

Although only two particular embodiments have been described in detail above, it will be appreciated that various changes, modifications and improvements can be made by a person skilled in the art without departing from the scope of the present invention as defined in the claims. For example, hardware aspects may be implemented as software where appropriate and vice versa. Thus, for example, the power controller may be implemented as a processor which executes instructions to provide the functionality. Furthermore, the instructions to implement the method may be provided on a computer readable medium.

1. A Universal Serial Bus, USB, dock comprising:
a USB data hub that does not provide negotiated power levels to devices connected to the USB dock;
at least a first port including a USB connection for connecting to a host device;
at least one second port for connecting to at least one peripheral device, the at least one second port including at least a USB connection connected to the USB data hub and a power connection;
a power source capable of providing power at a plurality of different power levels, the power source being connected to the power connection of the at least one second port; and
a power controller having a first connection to the power source, a second connection to the USB data hub and a third connection to the at least one second port, wherein the second connection is a USB data connection and the third connection is a power signalling connection;
wherein the power controller is configured to:
receive instructions from a host device connected to the first port via the USB data hub and the second connection, the instructions instructing the power controller to control the power source to provide power to a peripheral device connected to the at least one second port;
communicate with the peripheral device over the power signalling connection to determine parameters for power to be provided to the peripheral device; and
control the power source to provide power at one of the plurality of different power levels to the peripheral device via the power connection based on the instructions from the host device and the determined parameters.

2. The USB dock according to claim 1, wherein the power signalling connection allows communication using a USB Power Delivery protocol.

3. The USB dock according to claim 1, wherein the power signalling connection is connected to the power connection of the at least one second port.

4. The USB dock according to claim 1, wherein the power signalling connection is connected to a power signalling connection of the at least one second port.

5. The A USB dock according to claim 4, wherein the at least one second port is a USB Type C port.

6. The USB dock according to claim 1, wherein the dock comprises a plurality of second ports.

7. The USB dock according to claim 1, wherein the dock comprises one or more third ports for connection via non-USB connections to other peripheral devices.

8. The USB dock according to claim 1, wherein the instructions from the host device instruct the power controller to control the power source to provide power to the peripheral device based on a status of other peripheral devices connected to other second ports of the dock and on a capability of the power source.

9. The USB dock according to claim 1, wherein the instructions from the host device instruct the power controller to control the power source to sink power from the peripheral device.

10. The USB dock according to claim 1, wherein the instructions from the host device instruct the power controller to control the power source to sink power from one peripheral device connected to one second port and to provide power to another peripheral device connected to another second port.

11. The USB dock according to claim 1, wherein the power source is connected to a power connection of the first port.

12. The USB dock according to claim 1, wherein the power controller is connected to a power signalling connection of the first port.

13. A method of power delivery from a USB dock to a peripheral device, the USB dock comprising:
a USB data hub that does not provide negotiated power levels to devices connected to the USB dock;
at least a first port including a USB connection for connecting to a host device;
at least one second port for connecting to at least one peripheral device, the at least one second port including at least a USB connection connected to the USB data hub and a power connection;
a power source capable of providing power at a plurality of different power levels, the power source being connected to the power connection of the at least one second port; and
a power controller having a first connection to the power source, a second connection to the USB data hub and a third connection to the at least one second port, wherein the second connection is a USB data connection and the third connection is a power signalling connection;
wherein the method comprises the power controller:
receiving instructions from a host device connected to the first port via the USB data hub and the second connection, the instructions instructing the power controller to control the power source to provide power to a peripheral device connected to the at least one second port;
communicating with the peripheral device over the power signalling connection to determine parameters for power to be provided to the peripheral device; and
controlling the power source to provide power at one of the plurality of different power levels to the peripheral device via the power connection based on the instructions from the host device and the determined parameters.

14. The method according to claim 13, wherein communicating with the peripheral device over the power signalling connection uses a USB Power Delivery protocol.

15. The method according to claim 13, wherein communicating with the peripheral device uses the power connection of the at least one second port.

16. The method according to claim 13, wherein communicating with the peripheral device uses a power signalling connection of the at least one second port.

17. The method according to claim 14, wherein the power signalling connection of the at least one second port forms part of a USB Type C port.

18. The method according to claim 13, wherein the instructions from the host device instruct the power controller to control the power source to provide power to the peripheral device based on a status of other peripheral devices connected to other second ports of the dock and on a capability of the power source.

19. The method according to claim 13, wherein the instructions from the host device instruct the power controller to control the power source to sink power from the peripheral device.

20. The method according to claim 13, wherein the instructions from the host device instruct the power controller to control the power source to sink power from one peripheral device connected to one second port and to provide power to another peripheral device connected to another second port.
